(19) United States
(12) Patent Application Publication
(10) Pub. No.: US 2010/0128029 A1
(43) Pub. Date: May 27, 2010

(54) Processing Of A Desired Image Having A Dimension Not Equaling Powers Of 2 In A Swizzled Representation

(75) Inventor: Vijayendra Mohan Roy, Kolkata (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/277,281

(22) Filed: Nov. 24, 2008

(51) Int. Cl. G06T 15/00

(52) U.S. Cl. 345/419

(57) ABSTRACT

Reducing computational requirements when processing in a swizzled representation, an image portion having a dimension not equaling powers of 2. In an embodiment, the pixels of a source image are stored in a memory in a sequence determined by a swizzled representation. Data indicating boundaries of the image portion of interest are received. A counter is then set to indicate a first position in the swizzled sequence, and a check is performed of whether a position indicated by the counter corresponds to a pixel within the boundaries of the image portion. The counter is incremented by a number of subsequent pixels in the swizzled representation which are not part of the image portion if the position does not correspond to within the boundaries of the image portion. The pixel indicated by the counter is then processed.

### BACKGROUND

1. Technical Field

The present disclosure relates to image processing systems and more specifically to processing of a desired image having a dimension not equaling powers of 2 (i.e., not of the form 2̂N, wherein ̂ represents the exponentiation mathematical operation and N is a positive number) in a swizzled representation.

2. Related Art

A source image contains a set of pixels organized in a desired number of dimensions to represent a scene/object of interest. For example, an object may be represented by pixels in a 3-dimensional space. Each pixel thus represents the corresponding point/portion of the scene/object, as is well known in the relevant arts.

Source images are often represented in swizzled form. The general reason for such representation may be appreciated, for example, based on the below description with respect to FIGS. 1A, 1B, 2, 3A, 3B and 4A-4C.

FIG. 1A depicts a source image containing 16 pixels organized in a 2-dimensional space in one embodiment. For convenience, each of the pixels may be uniquely identified by their corresponding coordinate (such as 0, 1, 2 or 3) along the 2 dimensions conveniently named “X” and “Y”. As such, pixel 110 may be identified as (3, 0) or as 30 (in a compact notation used hereafter) indicating that pixel 110 is at coordinate 3 along the “X” dimension and at coordinate 0 along the “Y” dimension. Thus, the source image may be viewed as containing the pixels 00, 10, 20, 30, 01, 11, 21, 31, 02, 12, 22, 32, 03, 13, 23, 33.

FIG. 1B depicts the corresponding sequence of pixels (i.e., 00, 10, 20, 30, 01, 11, 21, 31, 02, 12, 22, 32, 03, 13, 23, 33) when the source image is stored in a linear order in one embodiment. The linear (row-major) order is obtained by storing the pixels in each row (having the same “Y” coordinate), one row after the other (as indicated by the arrows in the Figure).

FIG. 2 depicts a portion of a dynamic random access memory (DRAM) storing a source image in one embodiment. DRAM 200 s shown containing “m” rows, with each row containing “n” bits (each bit capable of storing a “0” or “1” value). Assuming each row of a DRAM can store 4 pixels, pixels 00, 10, 20 and 30 may be stored in a single row (e.g., row 0) of DRAM 200. Thus, each row of FIG. 1B may be stored in a corresponding row of DRAM 200.

One problem with such a linear storage is that unneeded data may be retrieved when a portion of interest of a source image is sought to be retrieved. For example, assuming that a texture is represented by pixels 00, 01, 10, and 11 of FIG. 1A, retrieval of the texture (desired image) may require retrieval of two rows (rows 0 and 1 of FIG. 2). As may be appreciated, some of the retrieved data is not required since such data does not represent the pixels of the texture/desired image.

The swizzled representation of FIG. 3A overcomes such a problem. As is well known, (2×2) pixels in Z formation forms a basic 2-dimensional (2-D) node 310 as shown in FIG. 3A. FIG. 3A thus has 4 basic 2-D nodes, which are traversed in Z formation again as shown in FIG. 3B.

Thus, the pixels 00, 10, 01, and 11 would be stored in row 0 of DRAM 200, pixels 20, 30, 21, and 31 in row 1, etc. This implies that the swizzled order is 00, 10, 01, 11, 20, 30, 21, 31, 02, 12, 03, 13, 22, 32, 23, and 33. As a result, the pixels corresponding to the texture in the above example may be retrieved in a single row access, thereby avoiding retrieval of unneeded data.

The swizzled representation can be extended to 3 dimensional space as illustrated with respect to FIGS. 4A-4C. The 3-D (3 dimensional) source image of FIG. 4A containing 64 pixels, are viewed as containing eight (2×2×2) basic 3-D nodes (such as node 410) as shown in FIG. 4B. Each basic 3-D node (such as node 410) is viewed as containing two 2-D nodes in corresponding planes as shown in FIG. 4C. The swizzled order for the first node 410 is 000, 100, 010, 110, 001, 101, 011, 111, and the second node 420 is 200, 300, 210, 310, 201, 301, 211, 311, etc., as is well known in the relevant arts.

From the above, it may be appreciated that all dimensions of a swizzled representation are equal and can be represented as powers of 2. There are several situations where a desired image (e.g., texture in the above example) has dimensions not equaling powers of 2 (i.e., 2̂N) or when all the dimensions are not equal. For example, a texture of interest may have such dimensions.

As another example, a source image or object itself may have such dimensions and non-image portions (buffer) may be added in the swizzled representation such that the swizzled representation has dimensions of (2̂N×2̂N×2̂N). Each pixel of the non-image portions may have some potentially arbitrary values. In such a case, the source image may be considered to be the desired image, when the entire source image is sought to be processed.

It is generally desirable that the desired image be processed while reducing resource requirements (e.g., computational requirements).

### BRIEF DESCRIPTION OF THE DRAWINGS

Example embodiments of the present invention will be described with reference to the accompanying drawings briefly described below.

FIG. 1A depicts a source image containing 16 pixels organized in a 2-dimensional space in one embodiment.

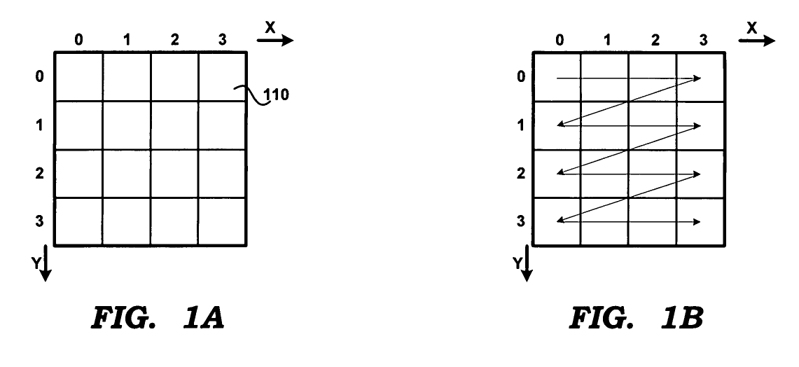

FIG. 1B depicts the corresponding sequence of pixels when a source image is stored in a linear (row-major) order in one embodiment.

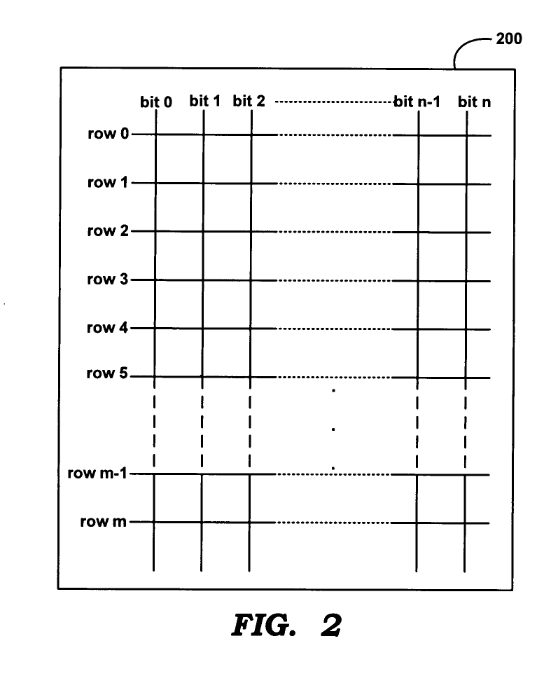

FIG. 2 depicts a portion of a dynamic random access memory (DRAM) storing a source image in one embodiment.

FIGS. 3A-3B together depicts the manner in which a source image is stored according to a swizzled representation in 2-dimensional space in one embodiment.

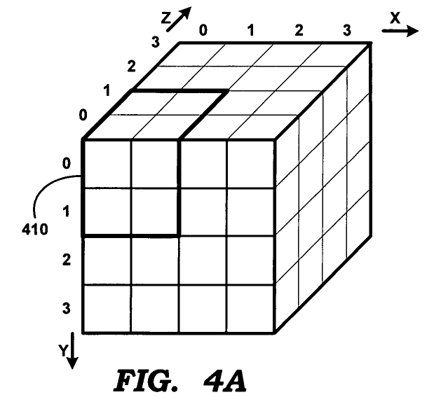

FIGS. 4A-4C together depicts the manner in which a source image is stored according to a swizzled representation in 3-dimensional space in one embodiment.

FIG. 5 is a block diagram illustrating the details of a digital processing system in which various aspects of the present invention are operative by execution of appropriate software instructions.

FIGS. 6A-6C respectively depict the manner of representation of 2×4, 8×2 and 2×3 textures of interest in one embodiment.

FIG. 7 depicts a flow chart illustrating the manner in which processing of a desired image having a dimension not equaling powers of 2 in a swizzled representation is performed according to an aspect of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present invention reduces computational requirements when processing, in a swizzled representation, an image portion having a dimension not equaling powers of 2. In an embodiment, the pixels of a source image are stored in a memory in a sequence determined by a swizzled representation. Data indicating boundaries of the image portion of interest are received.

A counter is then set to indicate a first position in the swizzled sequence, and a check is performed of whether a position indicated by the counter corresponds to a pixel within the boundaries of the image portion. The counter is incremented by a number of subsequent pixels in the swizzled representation which are not part of said image portion if the position does not correspond to within the boundaries of the image portion. The pixel indicated by the counter is then processed.

Due to such incrementing of the counter corresponding to the pixels not belonging to the image portion, computational requirements may be reduced.

The remaining pixels of the image portion may be processed by adding one to the counter to indicate a next position in the swizzled sequence, and performing the above noted actions of checking, incrementing and processing with the added value of the counter if it is confirmed that there is at least one more pixel to process in the image portion of interest.

Several aspects of the invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Digital Processing System

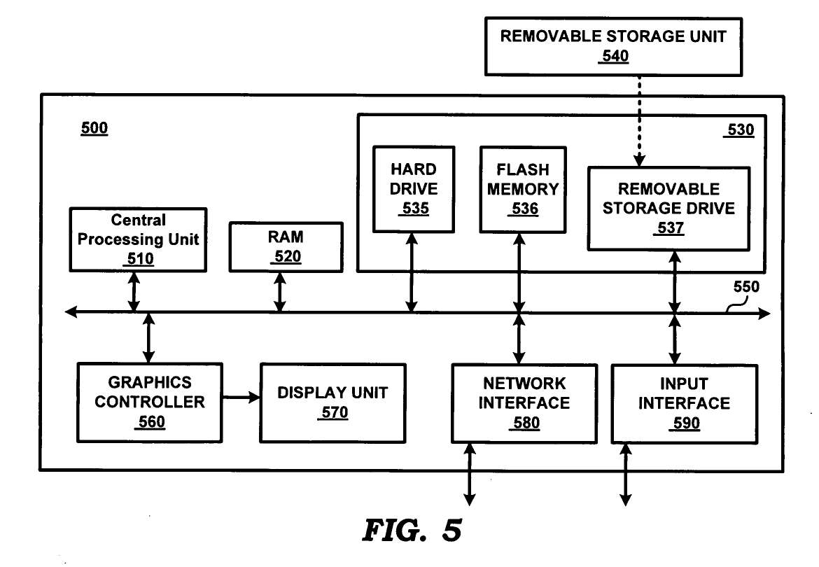

FIG. 5 is a block diagram illustrating the details of digital processing system 500 in which various aspects of the present invention are operative by execution of appropriate software instructions. Digital processing system 500 may correspond to any system implementing several features of the present invention. Though shown as a stand-alone system, the features of the invention can be implemented using cooperating computer systems connected by a network, etc.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

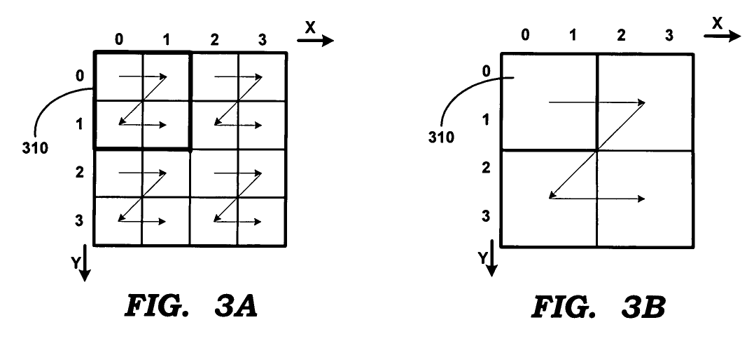

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit. RAM 520 may receive instructions from secondary memory 530 using communication path 550. RAM 520 may also be represented as an array as shown above with respect to FIG. 2 and store the swizzled representation of images.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other connected/cooperating systems.

Secondary memory 530 may contain hard drive 535, flash memory 536, and removable storage drive 537. Secondary memory 530 may store the data and software instructions, which enable digital processing system 500 (or processors 510, 560, etc.) to provide several features in accordance with the present invention.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 or graphics controller 560 may retrieve the software instructions, and execute the instructions to provide various features of the present invention described below.

The features of the invention will be clearer in comparison to a prior system, which does not use several features of the present invention. Accordingly the description is continued with respect to such a prior approach.

### 3. Prior Approach

In one prior approach, an image portion (texture) of interest in a 3-D swizzled representation is retrieved and processed using the following general logic (shown in terms of pseudo-code similar to C programming language):

```
I = 1;
while (I <= Vertex_Count)
{
    (X,Y,Z) = Get_Coordinates_Of_Vertex(I);
    if ((X <= Texture_Width) and (Y <= Texture_Height)
    and (Z <= Texture_Depth))
    {
        Process(X,Y,Z);
    }
    I = I + 1;
}
```

wherein Vertex_Count represents the total number of pixels in the swizzled representation of the source image (as well as the number of pixels in the swizzled sequence as stored in DRAM 200),

Texture_Width, Texture_Height and Texture_Depth, respectively represent width, height and depth (in number of pixels) of the texture/desired image to be retrieved and processed,

I is a counter which indicates the specific pixel in the swizzled sequence (as stored in DRAM 200) that is being retrieved and processed in a present iteration,

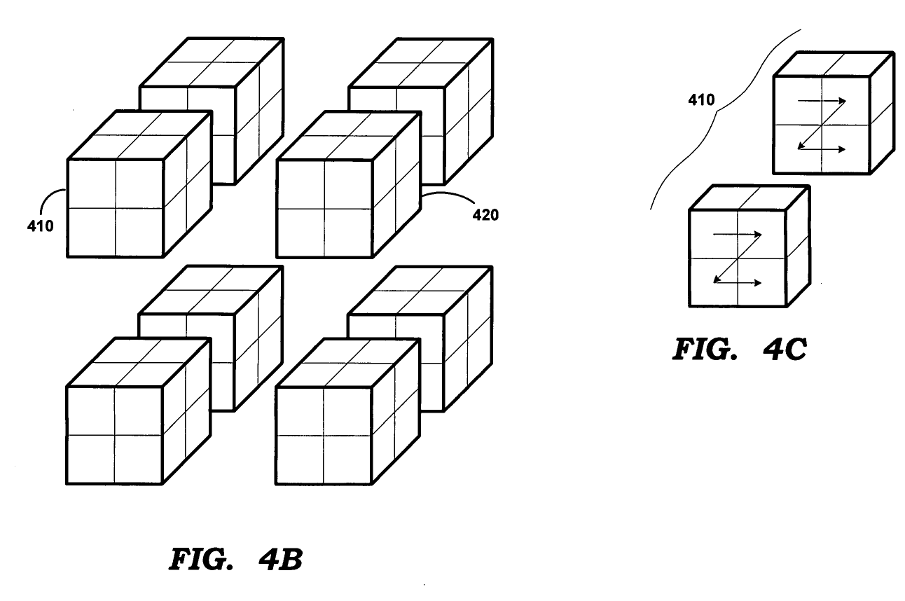

Get_Coordinates_Of_Vertex(I) is a function which translates the counter I to the coordinates (X, Y, Z) in the image space (e.g., that of FIG. 4A),

Process (X, Y, Z) is a function which retrieves and performs the desired processing of the specific pixel.

By examining the logic above, it may be appreciated that the “if” statement is executed for each of the pixels in the swizzled representation, even if the pixels do not belong to the texture of interest (e.g., either because the texture is only a portion of the source image or there may be arbitrary values to ensure appropriate dimensions amenable to swizzling, as described above).

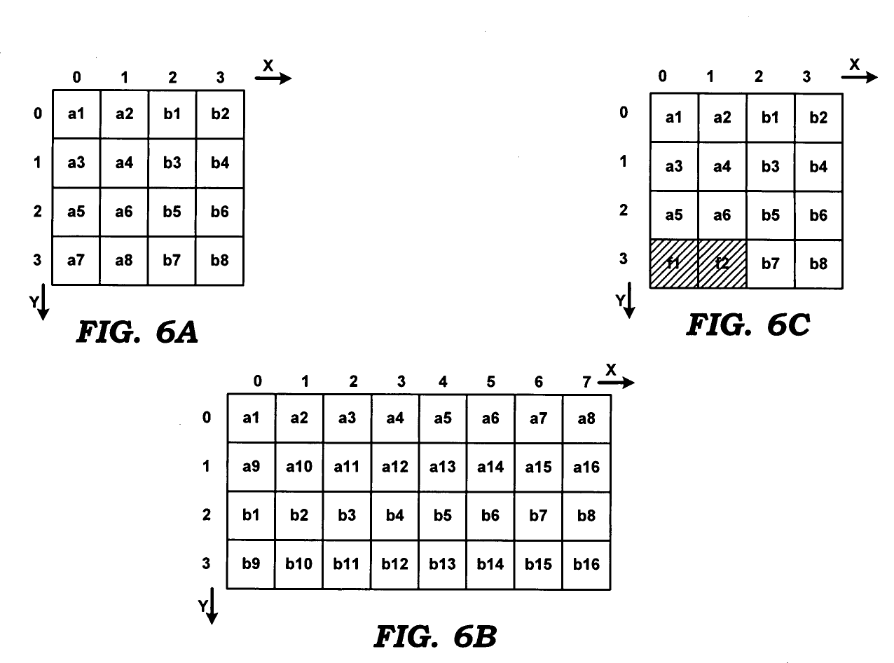

As an illustration, FIGS. 6A-6C respectively depict the manner of representation of 2×4, 8×2 and 2×3 textures of interest in one embodiment. Each Figure is shown containing the pixels of interest contained in the texture (prefix “a”), and the pixels that do not belong to the texture of interest (prefix “b”). Further, FIG. 6C is shown containing filler pixels (prefix “f”) having arbitrary values to ensure dimensions (powers of 2) amenable to swizzling for the image of interest. Accordingly, during the execution of the above logic, the “if” statement is executed for each of the buffer pixels (prefix “b”) and also for each of the filler pixels (prefix “f”).

Such “if” condition checks require computational resources and it is generally desirable to reduce computational requirement. The “if” conditions are further particularly undesirable in various pipelined architectures using multiple execution units because a branch (caused by an “if” condition) may require corresponding number of execution units to be allocated for look-ahead processing.

Various aspects of the present invention reduce such computational requirements as described below in further detail.

### 4. Inventive Approach

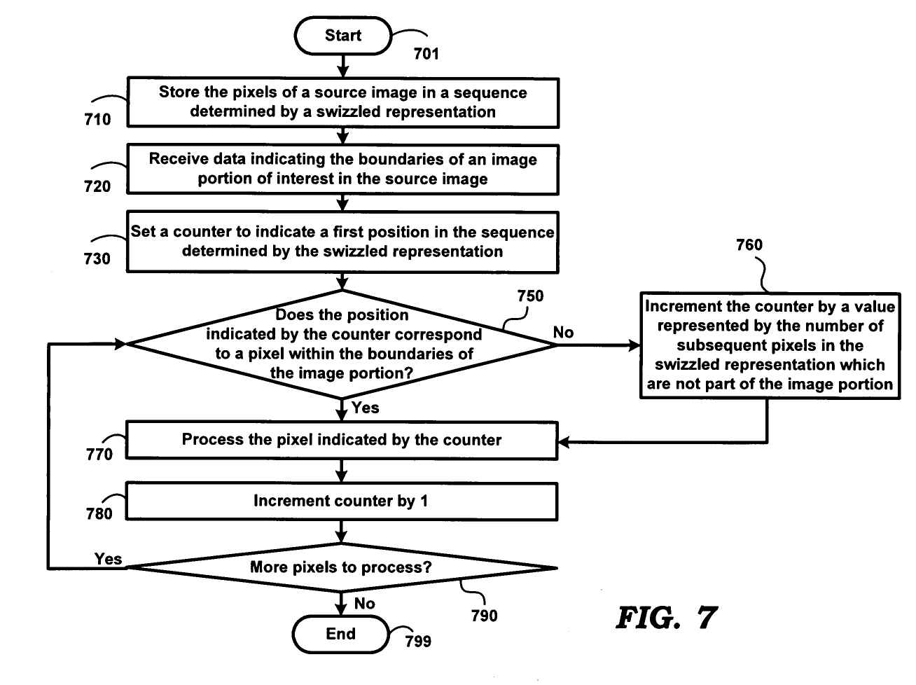

FIG. 7 depicts a flow chart illustrating the manner in which processing of a desired image having a dimension not equaling powers of 2 in a swizzled representation is performed according to an aspect of the present invention. The flowchart is described with respect to FIG. 5 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 701, in which control immediately passes to step 710.

In step 710, digital processing system 500 (CPU 510 or graphics controller 560) stores the pixels of a source image in a sequence determined by a swizzled representation. The pixels may be stored in DRAM 200 (volatile storage) of FIG. 2, or may be maintained in an appropriate (non-volatile) memory/storage.

In step 720, digital processing system 500 receives data indicating the boundaries of an image portion of interest in the source image. The boundaries may be specified, for example, as the number of pixels in each dimension and a reference coordinate. In a scenario that the desired image is of rectangular shape in a 2-D space, the boundaries may be specified as coordinates of the top left and bottom right corners of the rectangular shape.

In step 730, digital processing system 500 sets a counter to indicate a first position in the sequence determined by the swizzled representation (for example, stored in DRAM 200). As described below, the counter represents the specific pixel in the swizzled sequence that is being retrieved and processed in a present iteration, and as such may be equated to the variable “I” in the program logic of the prior approach, described above.

In step 750, digital processing system 500 checks whether the position indicated by the counter corresponds to a pixel within the boundaries of the image portion of interest. The checking may be performed by first translating the value of the counter to the coordinates in 3-D space (for example, using the function Get_Coordinates_Of_Vertex(I)) and then checking whether the translated coordinates corresponds to a pixel within the boundaries of the image portion of interest. Alternatively, such a checking may be performed in the swizzled representation as well, for example, by maintaining the sub-lists of counter values which fall within or outside of the image of interest.

In one embodiment, where the desired image reference coordinate is 000 in 3-D space, the checking is performed by checking whether the values of the translated (X, Y, Z) coordinates in each of the dimensions is less than or equal to the number of pixels specified as the boundary of the desired image in the corresponding dimension. Control passes to step 770 if all the translated coordinates are less than or equal to the corresponding number of pixels (indicating that counter indicate location corresponds to a pixel within the boundaries of the desired image) and to step 760 otherwise.

In step 760, digital processing system 500 increments the counter by a value (hereafter referred to as “increment factor”) represented by the number of subsequent pixels in the swizzled representation which are not part of the image portion. The increment factor may be determined based on the dimension in which the the translated (X, Y, Z) coordinates has been determined to be outside the boundary of the desired image (in step 750), as described below with examples. Control then passes to step 770.

In step 770, digital processing system 500 processes the pixel indicated by the counter. The processing of the pixel may involve retrieving the corresponding value from DRAM 200 and then performing a desired set of operations on the retrieved values. In step 780, digital processing system 500 increments counter by 1, indicating that the next pixel in the swizzled representation is to be processed during the next iteration.

In step 790, digital processing system 500 determines whether there are more pixels to process. The determination may be performed by checking whether the counter value is greater than the total number of pixels in the swizzled representation of the source image or as stored in DRAM 200 (equitable to the variable “Vertex_Count” in the program logic of the prior approach, describe above). Control passes to step 750 if there are more pixels to process (counter value less than or equal to Vertex_Count) and to step 799 otherwise. The flow chart ends in step 799.

Thus, by incrementing the counter by an appropriate increment factor in step 760, the execution of the “if” statement in the program logic of the prior approach is avoided for the pixels that are not contained in the image portion of interest, thereby reducing the computation requirements of processing the desired image. The manner in which the program logic of the prior approach may be modified to incorporate various aspects of the present invention is described below with examples.

### 5. Example Implementation

The prior approach of retrieving and processing an image portion (texture) of interest in a 3-D swizzled representation may be modified to incorporate various aspects of the present invention to result in the following general logic:

```
I = 1;
while (I <= Vertex_Count)
{
    (X,Y,Z) = Get_Coordinates_Of_Vertex(I);
    if ((X <= Texture_Width) and (Y <= Texture_Height)
    and (Z <= Texture_Depth))
    {
        Process(X,Y,Z);
        I = I + 1;
    }
    else
    {
        if (X > Texture_Width) Increment_Factor = X\hat{ }3;
        else if (Y > Texture_Height) Increment_Factor = 2 * (Y\hat{ }3);
        else Increment_Factor = 4 * (Z\hat{ }3);
        I = I + Increment_Factor;
    }
}
```

wherein the variables Vertex_Count, Texture_Width, Texture_Height, Texture_Depth, I, and the functions Get_Coordinates_Of_Vertex(I) and Process (X, Y, Z) have similar definitions/meaning to the prior approach and accordingly their description is not repeated here for conciseness. Variable Increment_Factor represents the value by which the counter “I” is to be incremented when the pixel corresponding to the current value of counter I is determined to be outside the boundaries of the desired image/texture.

It may be observed that the program logic of the prior approach has been modified to include a “else” block for the “if” statement which checks whether the current value of the counter “I” corresponds to a pixel contained in the boundaries of the desired image/texture. The “else” block contains “if-else” statements which together determine the increment factor (based on the dimension) and then increments the value of the counter by the determined increment factor.

The determination of the increment factor is performed by determining the specific dimension (X, Y or Z) along which the checked pixel is determined to be outside the boundaries of the desired image. In a scenario that the specific dimension is determined as the X dimension, the increment factor is calculated to be X̂3 (where ̂ represents the exponentiation operation).

For example, assuming a 3-D swizzled represenation for FIG. 6A, when the counter corresponds to pixel b1 (with coordinates 20), the increment factor is calculated to be 2̂3=8 pixels (corresponding to a single 3-D node). For the Y dimension, assuming a 3-D swizzled represenation for FIG. 6B, when the counter corresponds to pixel b1 (with coordinates 02), the increment factor is calculated as 2*Ŷ3=2*2̂3=16 pixels (corresponding to two 3-D nodes). Similarly, the increment factor for the Z dimension may be calculated to be 32 pixels corresponding to four 3-D nodes.

It may be noted that the above determination of the increment factor avoids the execution of the “if” condition only for the buffer pixels (prefix “b”). However, the “if-else” statements performing the calculation of the increment factor may be appropriately modified to skip the filler pixels (such as f1 and f2) as shown in FIG. 6C, as will be apparent to one skilled in the relevant arts by reading the disclosure provided herein.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention.

### 6. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of processing a source image, said source image containing a plurality of pixels, said method comprising:
storing said plurality of pixels, in a memory, in a sequence determined by a swizzled representation;
receiving data indicating boundaries of an image portion of interest in said source image;
setting a counter to indicate a first position in said sequence determined by the swizzled representation;
checking whether a position indicated by said counter corresponds to a pixel within the boundaries of the image portion;
incrementing said counter by an increment factor represented by a number of subsequent pixels in said swizzled representation which are not part of said image portion if said position does not correspond to within said boundaries; and
processing the pixel indicated by the counter.

2. The method of claim 1, further comprising:
adding a value of one to said counter to indicate a next position in said sequence; and
confirming whether there is at least one more pixel to process in said image portion of interest,
wherein said checking, said incrementing and said processing are performed with the added value of said counter if said confirming confirms that there is at least one more pixel to process in said image portion of interest.

3. The method of claim 2, wherein said checking comprises determining a specific dimension, outside of which said pixel indicated by said counter is present, wherein said increment factor contains a multiplication factor according to said specific dimension.

4. The method of claim 3, wherein said multiplication factors equals 1, 2 or 4 corresponding to whether said specific dimension is X-dimension, Y-dimension or Z-dimension respectively.

5. The method of claim 3, wherein said checking comprises:
converting said counter to a set of coordinates, each coordinate being along a corresponding dimension in a sequential order of representation of said source image;
comparing each of said set of coordinates with a corresponding boundary value of said image portion along the corresponding dimension to determine said specific dimension.

6. A machine readable medium carrying one or more sequences of instructions for causing a system to process a source image, said source image containing a plurality of pixels, wherein execution of said one or more sequences of instructions by one or more processors contained in said system causes said system to perform the actions of:
storing said plurality of pixels, in a memory, in a sequence determined by a swizzled representation;
receiving data indicating boundaries of an image portion of interest in said source image;
setting a counter to indicate a first position in said sequence determined by the swizzled representation;
checking whether a position indicated by said counter corresponds to a pixel within the boundaries of the image portion;
incrementing said counter by an increment factor represented by a number of subsequent pixels in said swizzled representation which are not part of said image portion if said position does not correspond to within said boundaries; and
processing the pixel indicated by the counter.

7. The machine readable medium of claim 6, further comprising one or more instructions for:
adding a value of one to said counter to indicate a next position in said sequence; and
confirming whether there is at least one more pixel to process in said image portion of interest,
wherein said checking, said incrementing and said processing are performed with the added value of said counter if said confirming confirms that there is at least one more pixel to process in said image portion of interest.

8. The machine readable medium of claim 7, wherein said checking comprises determining a specific dimension, outside of which said pixel indicated by said counter is present, wherein said increment factor contains a multiplication factor according to said specific dimension.

9. The machine readable medium of claim 8, wherein said multiplication factors equals 1, 2 or 4 corresponding to whether said specific dimension is X-dimension, Y-dimension or Z-dimension respectively.

10. The machine readable medium of claim 8, wherein said checking comprises:
converting said counter to a set of coordinates, each coordinate being along a corresponding dimension in a sequential order of representation of said source image;
comparing each of said set of coordinates with a corresponding boundary value of said image portion along the corresponding dimension to determine said specific dimension.

11. A system for processing a source image, said source image containing a plurality of pixels, said system comprising:
a processor and a memory, wherein said processor is operable to:
store said plurality of pixels, in said memory, in a sequence determined by a swizzled representation;
receive data indicating boundaries of an image portion of interest in said source image;
set a counter to indicate a first position in said sequence determined by the swizzled representation;
check whether a position indicated by said counter corresponds to a pixel within the boundaries of the image portion;
increment said counter by an increment factor represented by a number of subsequent pixels in said swizzled representation which are not part of said image portion if said position does not correspond to within said boundaries; and
process the pixel indicated by the counter.

12. The system of claim 11, wherein said processor is further operable to:
add a value of one to said counter to indicate a next position in said sequence; and
confirm whether there is at least one more pixel to process in said image portion of interest,
wherein said processor checks, increments and processes with the added value of said counter if said processor confirms that there is at least one more pixel to process in said image portion of interest.

13. The system of claim 12, wherein said checking comprises determining a specific dimension, outside of which said pixel indicated by said counter is present, wherein said increment factor contains a multiplication factor according to said specific dimension.

14. The system of claim 13, wherein said multiplication factors equals 1, 2 or 4 corresponding to whether said specific dimension is X-dimension, Y-dimension or Z-dimension respectively.

15. The system of claim 13, wherein said checking comprises:
converting said counter to a set of coordinates, each coordinate being along a corresponding dimension in a sequential order of representation of said source image;
comparing each of said set of coordinates with a corresponding boundary value of said image portion along the corresponding dimension to determine said specific dimension.
